(19) United States
(12) Patent Application Publication
(10) Pub. No.: US 2007/0029424 A1
(43) Pub. Date: Feb. 8, 2007

(54) Plate or plate segment and device with such plates or plate segments

(76) Inventors: Andreas Gorton-Hulgerth, Graz (AT); Josef Glawogger, St. Oswald (AT)

Correspondence Address: ALIX YALE & RISTAS LLP, 750 MAIN STREET, SUITE 1400, HARTFORD, CT, 06103, US

(21) Appl. No.: 11/498,628

(22) Filed: Aug. 3, 2006

(30) Foreign Application Priority Data
Aug. 4, 2005 (AT) A 1319/2005

(51) Int. Cl. B02C 7/12

(52) U.S. Cl. 241/298

(57) ABSTRACT

In plates or plate segments, e.g. in dispersing devices, circular elevations (9) and depressions (10) are provided in an arc-shaped arrangement. At least some of the elevations (9) form a continuous circular arc. This not only results in gentler fiber treatment due to the shearing forces being applied gently by means of friction, but also in the entire pulp suspension being dispersed, beaten/refined or deflaked more effectively.

### BACKGROUND OF THE INVENTION

The present invention relates to a working plate or a working plate segment with elevations and depressions in a circular arc-shaped arrangement, as well as a device with such plates or plate segments.

Such plates or plate segments are used, for example, in dispersing devices, beating/refining equipment, and in deflakers, as used in paper-making (hereinafter, “fiber working plate or plate segment”).

Dispersing devices, for example, are used to improve the quality of pulp suspensions, particularly to remove ink particles from the fibers and reduce the size of the ink particles and other impurities to a size that is not visible. For this purpose, the pulp suspension is conveyed radially outwards through a gap between two confronting circular plates, where one is fixed and the other is rotated, with the pulp suspension, or rather the fibers therein, being exposed to high shearing forces.

According to the state of the art, the plates or plate segments of, for example, the dispersing device have elevations arranged in a circular arc shape and depressions between these elevations, where the elevations are formed by oblong teeth aligned in radial direction. The rows of teeth engage the circular arc shaped depressions in the confronting plate, where some of the pulp suspension flows in radial direction between the teeth and some is exposed to the shearing forces between the teeth and the opposed plate.

### SUMMARY OF THE INVENTION

The present invention is directed to providing plates or plate segments and devices with such plates or plate segments, particularly for dispersing devices, but also for beating/refining equipment and deflakers with which dispersing, beating/refining and deflaking can be achieved more effectively on the one hand, and with gentle fiber treatment on the other hand.

According to the invention, the teeth are omitted, at least at some of the elevations, i.e., the elevations form a continuous circular arc. It has been demonstrated that such an embodiment of the elevations not only provides gentle fiber treatment because the shearing forces are applied gently by means of friction and not using the edges of the teeth, but also that the entire pulp suspension is dispersed, refined/beaten or deflaked more effectively. The entire pulp suspension must flow through the gap between the elevations and the opposed plate, and is thus treated without part of the pulp suspension being able to flow through the spaces between the teeth without being dispersed, beaten/refined or deflaked, as is possible according to the state of the art.

Furthermore, it has been demonstrated that the device according to the invention can be used preferably at higher throughput, also to increase the strength values (beating/refining).

The elevations and/or the depressions assigned to the elevations can either be rectangular, trapezoidal, triangular, round or rounded in places, where the cross-sectional shape of all elevations and/or depressions can be formed largely the same. As an alternative, it is, of course, also possible that the cross-sectional shape of individual elevations and/or depressions or of groups of elevations and/or depressions be shaped differently. The choice of shape of the elevations and the decision as to whether all elevations and/or depressions have the same or different shapes depends on the target application in each case, i.e. the later intended use of the pulp suspension and thus, the quality to be produced, and should be selected accordingly.

A preferred embodiment of the invention may also provide for the height and depth of the elevations and depressions, respectively, to increase radially from the inside towards the outside. This improves the dispersing or beating/refining effect or deflaking.

A preferred embodiment of the invention may provide in addition for elevations in a continuous circular arc and for elevations with gaps, which can, in particular, be tooth-shaped. In this embodiment, the elevations according to the invention in the shape of a continuous circular arc are combined with such elevations as are known from, the state of the art and are, for example, tooth-shaped. In this way, advantages of the elevations according to the invention in the shape of a continuous circular arc can be combined with advantages connected with tooth-shaped elevations.

Here, the invention may also provide for the elevations in the radial sector further towards the outer edge forming a continuous circular arc, while those in the radial sector closer to the centre have gaps, or vice versa. It is also possible to alternate elevations in a continuous circular arc and elevations with gaps.

Here, too, the combination selected depends again on the quality of the pulp suspension to be processed and the quality of the pulp suspension to be produced, respectively, and can be chosen arbitrarily under the present invention.

The invention has a further advantage in that wear and thus, wear-related costs, can be substantially diminished because the continuous surfaces of the circular arc shaped elevations are subject to much less wear than the teeth used in the state of the art, and in that the power consumption of the device can also be reduced. Finally, there is a further advantage for embodiments of devices operating under high steam pressure, particularly for dispersing, where the pulp suspension is fed in under high steam pressure, in that the steam-tightness of the device is much higher because the pressurised steam in the state of the art can escape radially outwards between the teeth, which is no longer possible with the continuous elevations used in the device according to the invention.

Within the scope of the invention it is also preferable for the gap width to decrease radially from the inside to the outside. This embodiment takes account of the fact that the cross-sectional surface of the gap would increase linearly from the inside to the outside with a constant gap width, causing the flow speed to drop accordingly, which can be prevented by the gap width decreasing in outward direction.

Further features and advantages of the invention are described in the following description of preferred embodiments of the invention, based on a dispersing unit and referring to the drawings.

### BRIEF DESCRIPTION OF THE DRAWING

In the drawing:

FIG. 1, shows schematically, the axial section of confronting plates for a dispersing device according to one embodiment of the invention;

FIG. 2, shows the front schematic view of a representative dispersing plate segment according to the invention;

FIGS. 3-8, show various cross-sectional plate segment shapes reflecting the line marked III-III in FIG. 2; and

FIG. 9 shows the front schematic view of another representative dispersing plate segment according to the invention.

### DESCRIPTION OF THE PREFERRED EMBODIMENTS

FIG. 1 shows a schematic view of two mounting plates 1, 2 of a dispersing device, where mounting plate 1 has a rigid bearing and mounting plate 2, secured to a drive shaft 3, rotates round an axis 4. The pulp suspension is fed in through a central opening 5 in the mounting plate 1, as illustrated symbolically by the arrows 6, and thus flows from the inside to the outside through a working gap 7 while it is being dispersed.

Normally, dispersing plate segments 8 with elevations 9 and depressions 10 that engage the elevations 9 and depressions 10 in the opposite dispersing plate segments are secured to the mounting plates 1 and 2. It is also possible to use annular plates instead of plate segments, which are either mounted rigidly on the mounting plates 1, 2 or directly on the drive shaft 3 or housing. As used herein, “circular plate” encompasses a solid circle or a circular ring or annulus.

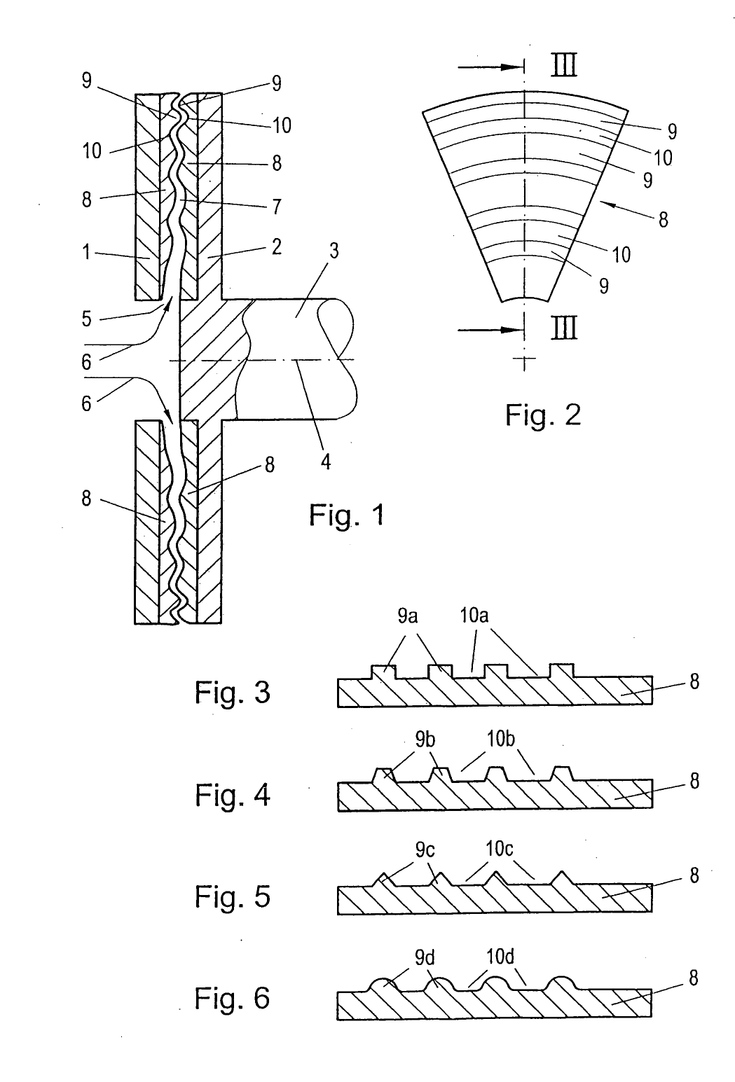

The elevations 9, as shown particularly in FIG. 2 on a dispersing plate segment 8, are arranged in a continuous circular arc, however it is possible in the scope of the invention not to arrange all elevations 9 in a continuous circular arc. As shown in FIG. 9, it is also possible to have, for example, only tooth-shaped elevations 11 known as such from the state of the art in the radially inner region, contrasting with only continuous circular arc shaped elevations 9 in the radially outer region, and vice versa. Based on the disclosure of FIG. 9, one can readily alternate continuous circular arc shaped elevations 9 individually with tooth-shaped elevations or to alternate groups of circular arc shaped elevations with groups of tooth-shaped elevations. It should be understood that the tooth shaped elevations 11 are arranged in a circular arc, but the elevations are discreet, i.e., interrupted by lateral spaces 12 between them.

In terms of cross-sectional shapes of the elevations 9, various embodiments are feasible, where examples are provided of rectangular elevations 9a in FIG. 3, of trapezoidal elevations 9b in FIG. 4, of triangular elevations 9c in FIG. 5, and of rounded elevations 9d in FIG. 6. Correspondingly, the depressions 10a to 10d are also rectangular, trapezoidal, or rounded.

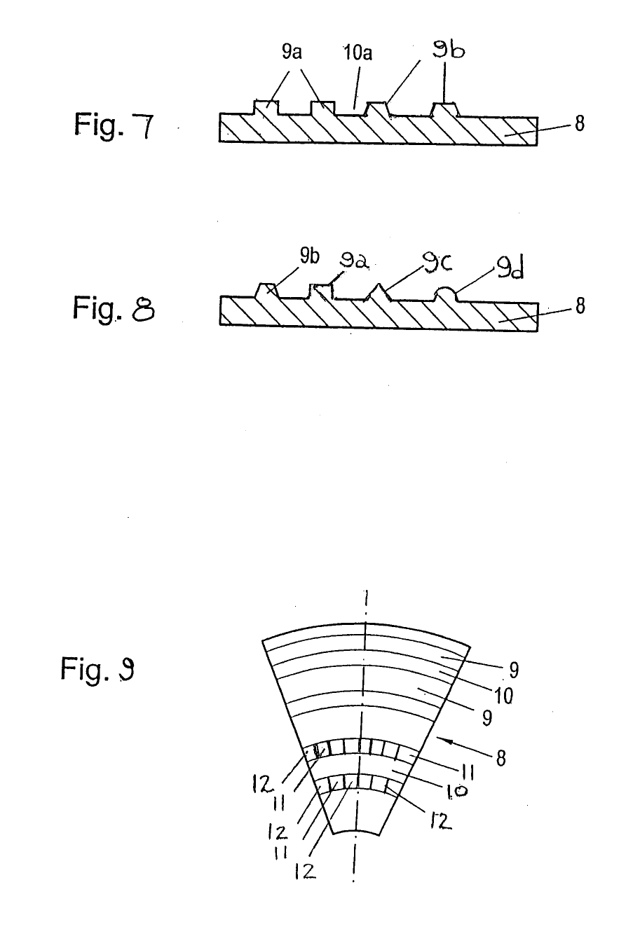

FIGS. 3 to 6 show dispersing plate segments 8 in which all elevations 9a to 9d on one segment 8 always have the same cross-sectional shape. It is also possible, however, to combine the cross-sectional shape of the individual elevations 9a to 9d and depressions 10a to 10d so that any desired combination of elevations 9a to 9d and corresponding depressions 10a to 10d can also be found on one segment 8. FIG. 7 shows differently shaped elevations at the radially inner and radially outer regions, whereas FIG. 8 shows a different cross sectional shapes for each elevation. These cross-sectional shapes and their combinations can be applied accordingly to annular plates.

As is shown in FIG. 1, the width of the working gap 7 can decrease from the inside to the outside so that, for example, a constant flow speed of the pulp suspension can be guaranteed from the inside to the outside.

1. A fiber working plate or plate segment with elevations and depressions in a circular arc-shaped arrangement, wherein the improvement comprises that at least some of the elevations form a continuous circular arc.

2. The plate or plate segment according to claim 1, wherein the cross-sectional shape of all elevations and/or depressions is rectangular.

3. The plate or plate segment according to claim 1, wherein the cross-sectional shape of all elevations and/or depressions is trapezoidal.

4. The plate or plate segment according to claim 1, wherein the cross-sectional shape of all elevations and/or depressions is triangular.

5. The plate or plate segment according to claim 1, wherein the cross-sectional shape of all elevations and/or depressions is rounded.

6. The plate or plate segment according to claim 1, wherein the cross-sectional shape of all elevations and/or depressions is substantially the same.

7. The plate or plate segment according to claim 1, wherein the cross-sectional shape of all elevations and/or depressions in a radially inner region are different from all elevations and/or depressions in a radially outer region.

8. The plate or plate segment according to claim 1, wherein the height and depth, respectively, of the elevations and depressions, increase radially from the inside toward the outside.

9. The plate or plate segment according to claim 1, wherein the cross sectional shapes of all the elevations and/or depressions are different.

10. The plate or plate segment according of claim 1, wherein some elevations in the circular arc arrangement are laterally spaced apart.

11. The plate or plate segment according to claim 10, wherein the elevations in a radially outer region form continuous circular arcs and the elevations in a radial inner region are laterally spaced.

12. The plate or plate segment according to claim 10, wherein the elevations in a continuous circular alternate radially with elevations with lateral spaces.

13. A fiber working device with ring shaped plates, where one is fixed and the other is rotated, and between which a working gap is formed, wherein the plates have elevations and depressions on confronting faces which engage each other alternately, the improvement comprising that the plates are formed by plate segments which define at least some elevations that are continuous circular arcs.

14. The device according to claim 13, wherein the working gap decreases radially from the inside to the outside.

15. The device of claim 13, wherein the device is a disperger.

16. A fiber working device with two circular plates, where one is fixed and the other is rotated, and between which a working gap is formed, wherein the plates have elevations and depressions on confronting faces which engage each other alternately, the improvement comprising that at least some elevations form a continuous circular arc.

17. The device of claim 16, wherein the working gap decreases radially from the inside to the outside.

18. The device of claim 16, wherein the device is a disperger.

19. The device of claim 16, wherein the cross-sectional shape of all elevations and/or depressions in a radially inner region are different from all elevations and/or depressions in a radially outer region.

20. The device of claim 16, wherein some elevations in the circular arc arrangement are laterally spaced apart.
